(19) United States
(12) Patent Application Publication
(10) Pub. No.: US 2008/0319632 A1
(43) Pub. Date: Dec. 25, 2008

(54) Combustion Control Apparatus and Method for Internal Combustion Engine

(75) Inventors: Shigeki Miyashita, Shizuoka-ken (JP); Mitsuyuki Kobayashi, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Toyota Jidosha Kabushiki Kaisha, Aichi-ken (JP); Denso Corporation, Kariya-city (JP)

(21) Appl. No.: 12/280,449

(22) PCT Filed: Sep. 13, 2007
(86) PCT No.: PCT/IB2007/002638

§ 371 Date: Aug. 22, 2008

(30) Foreign Application Priority Data
Sep. 14, 2006 (JP) 2006-249368

(51) Int. Cl. F02D 45/00

(52) U.S. Cl. 701/102

(57) ABSTRACT

A control apparatus for an internal combustion engine includes cylinder internal pressure sensors provided in each cylinder of an engine, and calculates a heat generation quantity in each cylinder based on the detected cylinder internal pressure and a crank angle. The control apparatus then obtains a combustion barycentric position, which is the crank angle at which a predetermined ratio of heat, of the total heat generation quantity in a combustion cycle, is generated. The control apparatus also calculates, based on the heat generation quantity, an actual starting point of combustion, which is a crank angle at which combustion actually started in the cylinder, and obtains the crank angle of the relative combustion barycentric position with respect to the actual starting point of combustion. When this crank angle exceeds an upper limit value, it is determined that combustion has truly deteriorated.

### BACKGROUND OF THE INVENTION

1. Field of the Invention

The invention relates to a combustion control apparatus and combustion control method for an internal combustion engine. More particularly, the invention relates to a control apparatus and a control method for an internal combustion engine, which determines the combustion state of a cylinder based on the combustion pressure in the cylinder.

2. Description of the Related Art

A combustion control apparatus for an internal combustion engine is known which provides a cylinder internal pressure sensor that is capable of detecting the pressure inside a cylinder in each cylinder of an internal combustion engine. This combustion control apparatus calculates the amount of heat generated (hereinafter also referred to as the (“heat generation quantity”) in each cylinder based on the cylinder internal pressure (i.e., the combustion pressure) detected while the engine is operating, and controls the combustion state of each cylinder based on this heat generation quantity.

Japanese Patent Application Publication No. 1-216073 (JP-A-1-216073), for example, describes one such combustion control apparatus.

The combustion control apparatus described in JP-A-1-216073 calculates the amount of heat generated (the heat generation rate) dQ at each unit crank-angle based on the combustion pressure in the cylinder. The combustion control apparatus then calculates the total amount of heat generated (total heat generation quantity) Qt in one combustion cycle of the cylinder, and obtains the crank angle (heat generation barycentric position) at which the heat generation quantity reaches 50% of the total heat generation quantity Qt from the heat generation rate for each crank angle.

With the apparatus described in JP-A-1-216073, the combustion state of the engine is adjusted so that it becomes good by correcting the spark timing (i.e., the timing at which spark is generated) of the engine so that the heat generation barycentric position comes to match a predetermined target position (crank angle). The heat generation barycentric position reflects the combustion pattern in the cylinder and indicates the truest combustion state. Therefore, a good combustion state in the cylinder can be maintained by adjusting the spark timing so that the heat generation barycentric position matches a position corresponding to an ideal combustion state that is set in advance.

However, in actuality problems may arise if the combustion state in the cylinder is determined solely by the combustion barycentric position, as it is in JP-A-1-216073.

As described in JP-A-1-216073, there is a close relationship between the combustion barycentric position and the combustion state in the cylinder. For example, in a lean burn engine or the like which operates with an air-fuel ratio much greater than the stoichiometric air-fuel ratio (i.e., a lean air-fuel ratio), the burning rate is slower than it is when combusting an air-fuel mixture of the stoichiometric air-fuel ratio. As a result, the pressure in the cylinder rises later, which may result in abnormal combustion in which less torque is generated.

In this case, the slower burning rate results in the combustion barycentric position becoming retarded. Therefore, when the retard amount of the combustion barycentric position is equal to or greater than a certain amount, combustion may be determined to be abnormal (or deteriorated) and a countermeasure such as advancing the spark timing or increasing the fuel injection quantity may be taken.

However, in actuality there are cases in which the combustion barycentric position is retarded even though abnormal combustion has not occurred and there is no decrease in generated torque.

For example, typically during abnormal combustion, ignition (the start of combustion) is retarded and the burning rate slows, and weak combustion continues until late into the combustion stroke. As a result, the generated torque decreases and the combustion barycentric position becomes retarded. However, even if ignition is retarded, the generated torque will not actually decrease unless the burning rate slows.

In this case, only ignition is retarded; the generated torque does not decrease nor is combustion deteriorated. However even in this case, if ignition of the air-fuel mixture (the start of combustion) is retarded, the overall combustion pattern is retarded compared to normal even if there is no decrease in the burning rate so the combustion barycentric position is also retarded.

In a lean burn engine or the like, the air-fuel ratio of the air-fuel mixture is typically lean so there is a tendency for the ignition of the air-fuel mixture to be retarded compared to the ignition of an air-fuel mixture of the stoichiometric air-fuel ratio. In a normal lean burn engine, the spark ignition energy of the spark plug is boosted so even if ignition is retarded, the burning rate once the air-fuel mixture is ignited is fast enough so that abnormal combustion usually does not occur. Also, normally ignition of the air-fuel mixture starts before top dead center (TDC) on the compression stroke, but when ignition is retarded it occurs in a state in which the overall compression ratio is high. As a result, when abnormal combustion does not occur, the burning rate increases.

That is, in a case such as that described above, ignition of the air-fuel mixture (the start of combustion) is retarded so even though the combustion barycentric position is retarded more than it is normally overall, the burning rate after combustion starts actually increases so the generated torque does not drop.

Therefore, when the combustion state is determined solely by the combustion barycentric position, as it is with the apparatus described in JP-A-1-216073, it is not possible to distinguish between true abnormal combustion and normal combustion in which ignition is simply retarded as described above. Therefore, normal combustion with retarded ignition may be erroneously determined as being abnormal combustion, and as a result, measures to improve combustion, such as advancing the spark timing or increasing the quantity of fuel injected, may be taken which may instead cause problems, e.g., they may adversely affect the quality of the exhaust gas.

### SUMMARY OF THE INVENTION

This invention thus provides a control apparatus and control method that accurately distinguishes between true abnormal combustion in which combustion actually deteriorates and combustion that appears to be abnormal combustion but in which combustion does not actually deteriorate, such as normal combustion with retarded ignition.

A first aspect of the invention relates to a combustion control apparatus for an internal combustion engine, which includes a cylinder internal pressure sensor that detects a combustion pressure in a cylinder, and a control portion which i) calculates a heat generation quantity in the cylinder based on the detected combustion pressure, ii) calculates a combustion barycentric position which is a crank angle at which the heat generation quantity in the cylinder during one combustion cycle of the cylinder reaches a predetermined first ratio with respect to a total heat generation quantity in the cylinder in the combustion cycle, iii) detects an actual starting point of combustion, which is a crank angle at which combustion actually started in the cylinder; and iv) determines that a combustion state of the cylinder has deteriorated when a difference between the actual starting point of combustion and the calculated combustion barycentric position is greater than a determining value that is set in advance.

In the first aspect, the first ratio may be any value between 40% and 60%, inclusive.

In the foregoing aspect, the actual starting point of combustion may be the crank angle at which the ratio of the heat generation quantity in the cylinder with respect to the total heat generation quantity in the cylinder reaches a predetermined second ratio which is smaller than the first ratio.

In this structure, the second ratio may be any value between 10% and 30%, inclusive.

In the foregoing aspect, the actual starting point of combustion may be the crank angle at which an increase rate of the heat generation quantity in the cylinder per a predetermined unit crank angle becomes equal to or greater than a predetermined value.

According to this aspect, the determination that combustion has deteriorated is made based not on the combustion barycentric position itself, as it is in the related art described in JP-A-1-216073, but based on a relative combustion barycentric position with respect to the actual starting point of combustion (i.e., the difference between the actual starting point of combustion and the combustion barycentric position).

Incidentally, the combustion barycentric position in JP-A-1-216073 is defined as the crank angle position when the heat generation quantity in the cylinder has reached 50% of the total heat generation quantity in the cylinder. In contrast, the combustion barycentric position in the invention may be defined as the crank angle position when the heat generation quantity in the cylinder has reached a predetermined ratio (this does not need to be a position where the heat generation quantity is strictly 50%, but may be any value between, for example, 400% and 60%, inclusive) of the total heat generation quantity in the cylinder.

In the foregoing structure, the control portion may improve combustion in the cylinder when it has been determined that combustion has deteriorated.

In this structure, the control portion may improve combustion in the cylinder by at least one of i) increasing a fuel injection quantity of the cylinder, ii) advancing a spark timing of the cylinder, and iii) advancing a fuel injection timing of the cylinder.

In the foregoing aspect and structure, the control portion may make an air-fuel ratio leaner by decreasing a fuel injection quantity of the cylinder when the difference between the actual starting point of combustion and the combustion barycentric position is equal to or less than a predetermined lower limit value.

In the foregoing structure, the control portion may make the determination only when the cylinder is being operated with an air-fuel ratio that is leaner than a predetermined air-fuel ratio.

That is, the control portion may perform an operation to improve combustion when it is determined that combustion has deteriorated.

A second aspect of the invention relates to a combustion control method for an internal combustion engine, which includes detecting a combustion pressure in a cylinder and calculating a heat generation quantity in the cylinder based on the detected combustion pressure; calculating a combustion barycentric position which is a crank angle at which the heat generation quantity in the cylinder during one combustion cycle of the cylinder reaches a predetermined first ratio with respect to a total heat generation quantity in the cylinder in the combustion cycle; detecting an actual starting point of combustion, which is a crank angle at which combustion actually started in the cylinder; and determining that a combustion state of the cylinder has deteriorated when a difference between the actual starting point of combustion and the calculated combustion barycentric position is greater than a determining value that is set in advance.

As described above, it is possible to accurately determine when combustion has deteriorated, such as during abnormal combustion, so a combustion improvement operation can be performed only when combustion has truly deteriorated. As a result, a combustion improvement operation prompted by an erroneous determination can be prevented from being performed, thus preventing adverse effects such as a deterioration of the quality of the exhaust gas, a reduction in fuel efficiency, and the like that may result from performing an combustion improvement operation when it is not necessary.

Also, the combustion improvement operation can include, for example, increasing the fuel injection quantity, advancing the spark timing, and advancing the fuel injection timing. Increasing the fuel injection quantity lowers the air-fuel ratio (makes it richer) which promotes ignition and increases the burning rate after ignition, thereby improving combustion. Also, advancing the spark timing (i.e., the timing at which a spark is generated) causes ignition to occur earlier (i.e., advances the ignition timing or the timing at which the air-fuel ratio is ignited by the spark) and advancing the fuel injection timing improves vaporization of the air-fuel mixture which advances the ignition timing and thus improves combustion.

Incidentally, normal combustion with retarded ignition tends to occur more easily with a leaner air-fuel ratio of the air-fuel mixture. Therefore, the determination with respect to combustion deterioration and the combustion improvement operation when combustion has deteriorated may be performed only when the engine is operating with an air-fuel ratio that is leaner than a predetermined air-fuel ratio.

According to this aspect, it is possible to accurately distinguish between true abnormal combustion and combustion that appears to be abnormal combustion but is in fact not, such as normal combustion with retarded ignition, which was difficult to do conventionally. As a result, it is possible to accurately determine whether combustion has deteriorated in a cylinder.

Also, according to this aspect, the combustion improvement operation is performed only when combustion has truly deteriorated. As a result, a deterioration of the quality of the exhaust gas or a reduction in fuel efficiency and the like, which may occur as a result of a combustion improvement operation being performed due to an erroneous determination, can be prevented.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram schematically showing an example embodiment in which the invention has been applied to an internal combustion engine of a vehicle;

FIG. 2 is a graph showing a frame format of the change in the pressure in a cylinder during the compression stroke according to the combustion state in order to illustrate the abnormal combustion determining principle of the invention;

FIG. 3 is a graph showing the changes in the heat generation quantities of the combustion states shown in FIG. 2;

FIG. 4 is a graph illustrating a combustion state determining principle of the invention;

FIG. 5 is a first part of a flowchart that illustrates a combustion state determination and a combustion improvement operation according to an example embodiment of the invention; and

FIG. 6 is a second part of the flowchart that illustrates a combustion state determination and a combustion improvement operation according to the example embodiment of the invention.

### DETAILED DESCRIPTION OF EMBODIMENTS

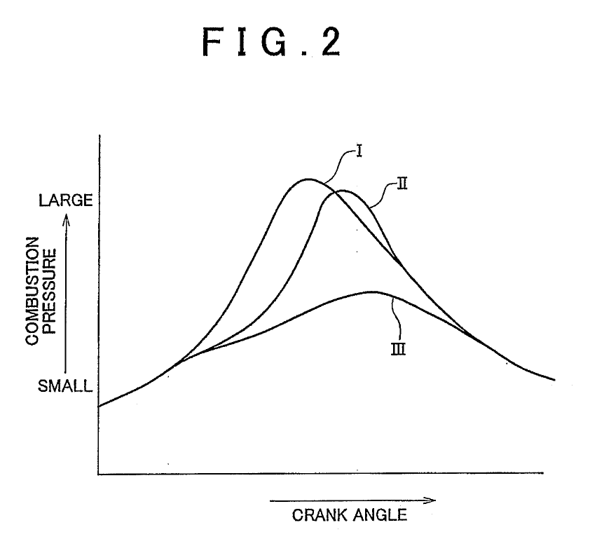

Hereinafter, an abnormal combustion determining principle of the invention will be described. FIG. 2 shows the change in the pressure in a cylinder during the combustion stroke according to the combustion state. The vertical axis in the drawing represents the combustion pressure and the horizontal axis represents the crank angle.

In FIG. 2, curve I shows the pressure change during normal combustion, curve III shows the pressure change during abnormal combustion, and curve II shows the pressure change during normal combustion with retarded ignition.

As shown in FIG. 2, with abnormal combustion (curve III), the pressure starts to rise (i.e., ignition) later than it does with normal combustion (curve I) and the rate at which the pressure increases (i.e., the burning rate) is also slower than it is with normal combustion. Because of this, the highest pressure in the cylinder is also much lower than it is with normal combustion, resulting in much less output torque from the cylinder.

On the other hand, in normal combustion with retarded ignition (curve II), ignition is later than it is in normal combustion. Once ignition occurs, however, the rate at which the pressure increases (i.e., the burning rate) is comparable to what it is with normal combustion and the highest pressure in the cylinder is also about the same so the output torque from the cylinder does not decrease.

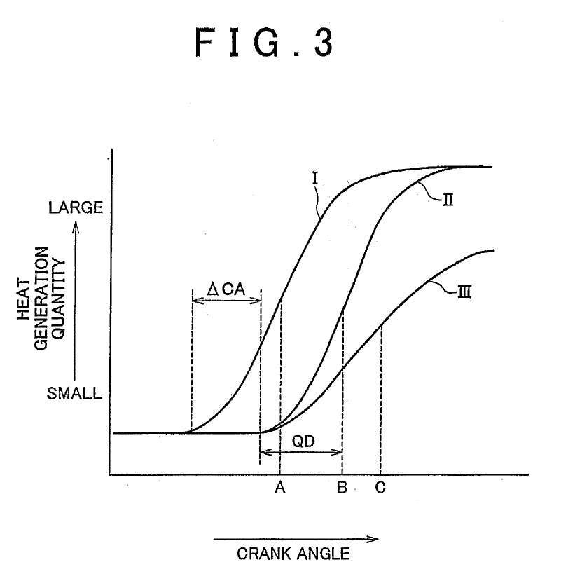

FIG. 3 is a graph showing the change in the heat generation quantity of each combustion state shown in FIG. 2. As will be described later, the heat generation quantity is obtained by successively integrating the heat generation rate (i.e., the heat generation quantity per unit crank angle) calculated based on the volume and the pressure in the cylinder at each crank angle.

As shown in FIG. 3, the start of the increase (ignition) is later and the increase rate (burning rate) is slower with abnormal combustion (curve III) than they are with normal combustion (curve I) so the total heat generation quantity ultimately reached is also less with abnormal combustion than it is with normal combustion.

In contrast, with normal combustion with retarded ignition (curve II), although the heat generation quantity starts to increase (i.e., ignition) later, once ignition occurs, the increase rate (i.e., the burning rate) is equal to the increase rate (i.e., the burning rate) with normal combustion (curve I) so the total heat generation quantity ultimately reached is comparable to that of normal combustion. Therefore, with normal combustion with retarded ignition (curve II), the cylinder output torque is equivalent to the cylinder output torque with normal combustion (curve I) so there is no decrease in output torque.

Next, the combustion barycentric position of each combustion state shown in FIG. 3 will be described. In the invention, the combustion barycentric position is defined as the crank angle at which the heat generation quantity of a predetermined ratio of the total heat generation quantity at a predetermined timing is reached in the cylinder (in FIG. 3 this is shown as 50%, but it is clear that the same results as shown in FIG. 3 can also be obtained using any ratio between 40% and 60%).

As shown in FIG. 3, with abnormal combustion (curve III), ignition is later and the burning rate is slower so the combustion barycentric position (C) is quite retarded compared to the combustion barycentric position (A) of normal combustion (curve I). In contrast, with normal combustion with retarded ignition (curve II) as well, the combustion barycentric position (B) is retarded compared with the combustion barycentric position (A) during normal combustion and is closer to the combustion barycentric position (C) during abnormal combustion due to the fact that ignition is retarded.

Therefore, if abnormal combustion is determined based only on the combustion barycentric position, normal combustion with retarded ignition may be determined as being abnormal combustion when the extent to which ignition is retarded is fairly large. As a result, combustion may be determined as being abnormal despite the fact that there is actually no decrease in output torque.

This invention correctly distinguishes between normal combustion with retarded ignition and abnormal combustion according to the method described below by focusing on the differences in the characteristics of i) the retard amount of the combustion barycentric position according to ignition retard, and ii) the retard amount of the combustion barycentric position according to a decrease in the burning rate.

As described above, the burning rate after ignition during normal combustion with retarded ignition is equivalent to that during normal combustion despite the fact that the ignition timing is retarded. Also, the heat generation pattern after ignition during normal combustion with retarded ignition is almost the same as it is during normal combustion.

Therefore, almost all of the retard amount of the combustion barycentric position during normal combustion with retarded ignition is due to the retard amount of the ignition itself.

Accordingly, with normal combustion with retarded ignition, the combustion barycentric position can be made almost the same as it is with normal combustion by correcting it by an amount corresponding to the retard amount of the ignition retard.

On the other hand, with abnormal combustion, the burning rate also decreases even though the ignition timing is retarded so the combustion period is longer than it is with normal combustion. Therefore, the retard amount of the combustion barycentric position during abnormal combustion is the result of both the retard amount of the ignition timing and the lengthened combustion period so the combustion barycentric position will still be retarded with respect to the combustion barycentric position during normal combustion if only the retard amount of the ignition retard is corrected.

Therefore, it is therefore possible to correctly distinguish between abnormal combustion and normal combustion with retarded ignition by correcting the calculated combustion barycentric position by the retard amount of the ignition retard (i.e., by the retard amount of the timing at which combustion actually starts).

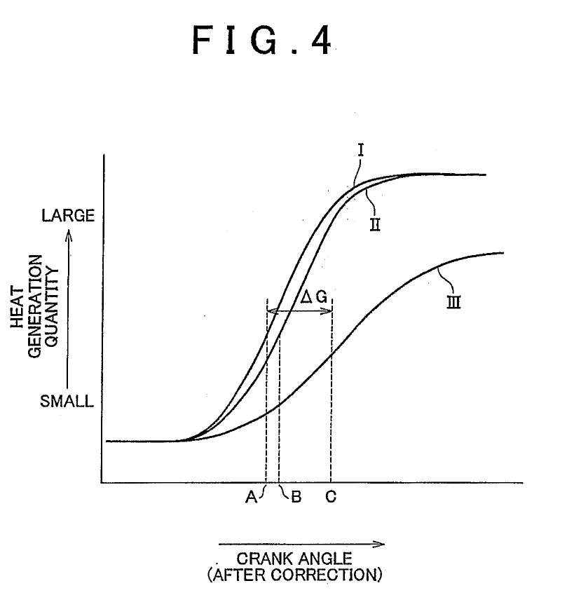

FIG. 4 is a graph showing the heat generation quantity curve in FIG. 3 shifted to the advance side by the ignition retard amount, i.e., by the retard amount (shown by ΔCA in FIG. 3) of the timing at which combustion starts with respect to the timing at which combustion starts during normal combustion.

As shown in FIG. 4, the combustion pattern (heat generation pattern) of normal combustion with retarded ignition (curve II) according to the foregoing correction almost matches that of normal combustion (curve I), and the combustion barycentric positions (A and B) also almost match.

In contrast, with abnormal combustion (curve III), even if the ignition retard ΔCA is corrected, the heat generation pattern does not match that of normal combustion (curve I) so the combustion barycentric position (C) is still retarded compared to the combustion barycentric position (A) of normal combustion (ΔG in FIG. 4).

Accordingly, it is possible to accurately distinguish between abnormal combustion and normal combustion with retarded ignition by determining that abnormal combustion has occurred when the retard amount of the combustion barycentric position after the correction is greater than a determining value that is set beforehand.

Incidentally, in the foregoing description an example is described in which the combustion barycentric position is corrected by the amount that the ignition timing for each combustion is retarded with respect to the ignition timing of normal combustion. However, instead of this correction, it is also possible to accurately distinguish between abnormal combustion and normal combustion with retarded ignition using a crank angle QD (FIG. 3) from the point that combustion actually starts until the combustion barycentric position (i.e., a difference between the point that combustion actually starts and the combustion barycentric position) in each heat generation pattern. That is, it is possible to accurately distinguish between abnormal combustion and normal combustion with retarded ignition by determining that abnormal combustion has occurred when that crank angle QD is equal to or greater than a predetermined determining value. The principle of this method is the same as that of the foregoing method, as is the result that is obtained.

Incidentally, even if there is some combustion fluctuation, a fixed zone which includes the actual combustion period (from the start of combustion until the end of combustion) may be set as the zone within which the heat generation quantity is calculated in order to calculate the total heat generation quantity in the cylinder and the combustion barycentric position. The heat generation quantity may be calculated anywhere within this zone.

Furthermore, in the invention the actual starting point of combustion must be set, but this may be difficult to do with actual operation. Therefore, instead of the actual starting point of combustion, for example, the point at which the heat generation quantity in the cylinder reaches a predetermined value (such as fixed ratio around 10% to 30% of the total heat generation quantity in the cylinder) may be used as the actual starting point of combustion.

Also, the point at which the heat generation rate (i.e., the heat generation quantity per unit crank angle), which is the increase rate of the heat generation quantity in the cylinder after combustion starts, becomes equal to or greater than a predetermined value may also be used as the actual starting point of combustion.

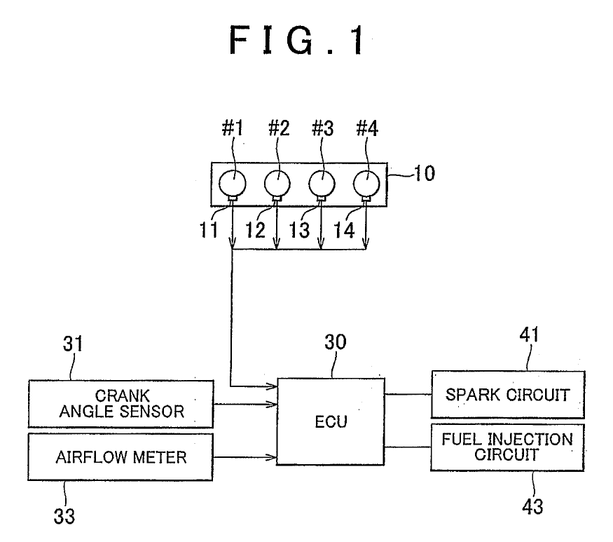

Hereinafter, an example embodiment of the invention will be described with reference to the drawings. FIG. 1 is a block diagram schematically showing an example embodiment in which the invention has been applied to an internal combustion engine of a vehicle (hereinafter simply referred to as “internal combustion engine” or simply “engine”).

In this example embodiment, the internal combustion engine 10 shown in FIG. 1 is a four cylinder spark-ignition engine having four cylinders denoted as #1 to #4. Each cylinder #1 to #4 is provided with a cylinder internal pressure sensor 11 to 14, respectively, capable of detecting the internal pressure of the cylinder.

In this example embodiment, the cylinder internal pressure sensors 11 to 14 are a known type of pressure sensor that uses a piezoelectric element or the like. Any one of various types of cylinder internal pressure sensors can be used as the cylinder internal pressure sensors of this example embodiment. For example, a type of cylinder pressure sensor can be used that is arranged in the cylinder block or the cylinder head and communicated via a connection hole to the inside of the cylinder, or a washer type cylinder pressure sensor can be used that is mounted on a spark plug, not shown, in each cylinder.

In the example embodiment, an electronic control unit (ECU) 30 is formed of a known type of digital computer that includes a CPU, RAM, ROM, and an input/output port. In this example embodiment, in addition to performing basic engine control such as fuel injection control and spark timing control of the engine 10, the ECU 30 also performs an operation for determining whether combustion is normal or abnormal (hereinafter simply referred to as a “combustion determination operation”) and an operation for improving combustion (hereinafter simply referred to as a “combustion improvement operation”). In the combustion determination operation, the ECU 30 first calculates the combustion barycentric position and the heat generation quantity in the cylinder based on the combustion pressure in the cylinder that was detected by the cylinder internal pressure sensors 11 to 14. Then the ECU 30 determines whether the combustion state in the cylinder has deteriorated based on the calculated combustion barycentric position. In the combustion improvement operation, the ECU 30 improves the combustion state in the cylinder based on the detected results. These operations (i.e., the combustion determination operation and the combustion improvement operation) will both be described in detail later. The ECU 30 functions as a control portion.

In order to execute these controls, various signals are input to the input port of the ECU 30, including a signal indicative of the output voltage from the cylinder internal pressure sensors 11 to 14 via an AD converter, not shown, a pulse signal indicative of the crankshaft rotation angle CA of the engine from a crankshaft angle sensor 31 arranged near a crankshaft of the engine 10, and a signal indicative of the intake air flowrate of the engine from an airflow meter 33 provided in an intake passage of the engine 10.

Also, the output port of the ECU 30 is connected to a spark circuit 41 and a fuel injection circuit 43 by which the ECU 30 controls the spark timing and the fuel injection of the engine 10.

The ECU 30 calculates the engine speed N (rpm) from the frequency of the pulse signal input from the crank angle sensor 31, and also calculates the current crankshaft rotation angle (i.e., the crank angle) from the number of crank angle pulses after a reference position signal, which is generated separately every time the piston reaches top dead center (TDC) of the combustion stroke in a specific cylinder (such as cylinder #1), is input.

Also, the ECU 30 sets the engine fuel injection quantity and the engine spark timing based on the engine speed and the flowrate of the intake air of the engine detected by the airflow meter 33. Because the fuel injection quantity and the spark timing can each be calculated by a known method, a detailed description of these calculations will be omitted here.

Next, the combustion determination operation of this example embodiment will be described. As described above, in this example embodiment, the determination as to whether combustion has deteriorated in the cylinders is made based on the combustion barycentric position.

In this example embodiment, after combustion starts, the combustion barycentric position is calculated as the crank angle at which the heat generation quantity in the cylinder has reached a predetermined ratio of the total heat generation quantity of one stroke cycle of the cylinder.

Also, the heat generation quantity in the cylinder during a given period is obtained by adding up the heat generation quantities per unit crank angle (e.g., per 1° crank angle), i.e., the heat generation rate dQ, over that period.

Here, as is well known, the heat generation rate dQ is a function of the crank angle θ and can be expressed by Expression (1) below.

dQ(θ)=(1/(κ−1))×(κ×P(θ)×dV(θ)+V(θ)×dP(θ)) Expression (1)

Here, dQ(θ) is the heat generation rate at crank angle θ, κ is the specific heat ratio of the air-fuel mixture, P(θ) is the pressure in the cylinder at crank angle θ, dP(θ) is the rate of change of that pressure, V(θ) is the volume of the combustion chamber at crank angle θ, and dV(θ) is the rate of change of that volume.

The ECU 30 calculates the heat generation rate at each crank angle θ for each unit crank angle (e.g., for each 1°) using the calculation formula in Expression (2) that shows the expression of the foregoing heat generation rate dQ(θ) in discrete form.

dQ(θ)=(1/(κ−1))×(κ×P(θ)×(V(θ)−V(θᵢ₋₁))+V(θ)×(P(θ)−P(θᵢ₋₁))) Expression (2)

Here, V(θᵢ₋₁) and P(θᵢ₋₁) represent the combustion chamber volume V and the pressure P, respectively, at the crank angle a unit crank angle before θ.

The ECU 30 detects the pressure P(θ) in the cylinders using the cylinder internal pressure sensors 11 to 14 for each crank angle θ and calculates the combustion chamber volume V(θ) from crank angle θ. Using these, the ECU 30 then calculates the heat generation rate dQ(θ) at crank angle θ from the foregoing expression, and stores the result in a predetermined storage area in the RAM of the ECU 30.

The ECU 30 calculates the total heat generation quantity Q in the cylinder by adding up the heat generation rates dQ(θ) for each crank angle that was calculated as described above over the combustion period (i.e., from crank angle θs at the start of combustion until crank angle θe at the end of combustion).

The ECU 30 calculates the heat generation quantity Q(θ) up until the current crank angle by adding the heat generation rate dQ(θ) calculated as described above at the current crank angle to the last integrated value Q(θ) (i.e., the integrated value that was calculated at the crank angle a unit crank angle before the current crank angle).

That is, the total heat generation quantity Q is calculated by repeating the operation in the calculation formula shown in Expression (3) from the crank angle θs at the start of combustion until the crank angle θe at the end of combustion.

Q(θ)=Q(θᵢ₋₁)+dQ(θ) Expression (3)

Incidentally, in actuality, the heat generation rate is zero when combustion is not being performed so the even if the actual combustion zone fluctuates, the foregoing integration is such that a fixed zone that includes the entire combustion zone is uniformly set and the calculation of the heat generation rate for each crank angle, as well as the integration of those heat generation rates, is performed within this zone.

Also, the ECU 30 stores the heat generation quantity integrated value Q(θ) at each crank angle in a predetermined storage area in the RAM, and after calculating the total heat generation quantity Q, uses it to calculate the combustion barycentric position as described below.

In this example embodiment, the combustion barycentric position is defined as the crank angle at which the heat generation quantity in the cylinder after combustion starts reaches a predetermined ratio of the total heat generation quantity. Also, this predetermined ratio does not need to be strictly 50%, but can be set to an appropriate value a between 40% and 60%, for example.

After calculating the total heat generation quantity Q as described above, the ECU 30 obtains two crank angles that satisfy the relationship shown in Expression (4) referencing the heat generation quantity integrated value Q(θ) for each crank angle that was stored as described above. A combustion barycentric position θg is then calculated by interpolating it between these two crank angles.

Q(θᵢ₋₁)<Q×α<Q(θ) Expression (4)

Next, the setting of the actual starting point θs of combustion will be described. In this example embodiment, the crank angle at which the heat generation quantity in the cylinder reaches a predetermined ratio β is used as the actual starting point of combustion. This ratio β is a value that is of course less than the ratio α when calculating the combustion barycentric position, and is an appropriate value between 10% and 30%, for example.

The ECU 30 calculates the actual starting point θs of combustion that will satisfy the relationship shown in Expression (5) using the same method as that for calculating the combustion barycentric position using the heat generation quantity integrated value Q(θ) for each crank angle that was stored as described above,

Q(θ)=Q×β Expression (5)

As described above, after calculating the combustion barycentric position θg and the actual starting point θs of combustion, the ECU 30 calculates the difference between the combustion barycentric position θg and the actual starting point θs of combustion (i.e., θd=θg−θs), i.e., the crank angle after combustion actually starts in the cylinder until it reaches the combustion barycentric position. The ECU 30 then determines whether combustion is deteriorated in the cylinder based on this θd.

As described above, during normal combustion with retarded ignition, the combustion barycentric position θg itself is retarded with respect to the combustion barycentric position of normal combustion. However, the period (crank angle) from the starting point θs of combustion until the combustion barycentric position θg is substantially the same as it is with normal combustion. In contrast, when combustion is deteriorated, as it is in abnormal combustion, for example, not only is the combustion barycentric position θg retarded compared with the combustion barycentric position of normal combustion, but the crank angle from the starting point θs of combustion until the combustion barycentric position θg is also increased.

Therefore, when the θd is greater than a determining value that is set in advance, it can be determined that abnormal combustion is occurring. Incidentally, this determining value changes depending on the type and model of the engine so it is preferably set by testing using an actual engine.

In this example embodiment, the combustion improvement operation is further performed if it is determined that combustion has deteriorated.

In the combustion improvement operation of this example embodiment, one or more measures such as increasing the fuel injection quantity, advancing the spark timing, and advancing the fuel injection timing are taken.

When the fuel injection quantity is increased the air-fuel ratio decreases (i.e., shifts to the rich side) so the burning rate after ignition increases, thus preventing abnormal combustion caused by a decrease in burning rate from occurring. Also, similarly when the spark timing is advanced, ignition occurs earlier (i.e., the ignition timing or the timing at which the air-fuel ratio is ignited by the spark is advanced). Increasing the fuel ignition quantity while at the same time advancing the spark timing in this way improves combustion. Further, when the fuel injection timing is advanced, the fuel has more time to vaporize so ignition and combustion of the fuel improves, thereby improving combustion.

Incidentally, in this example embodiment, even if it is determined that combustion is normal, if the crank angle θd from the actual start of combustion until the combustion barycentric position is equal to or less than a predetermined lower limit value, the combustion state is adjusted. A small θd means a fast burning rate. In this case, it means that normal operation is possible even if the burning rate was to become even slower, in other words, even if the air-fuel ratio was made lean. Also, in this case, it is preferable to operate the engine with an even leaner air-fuel ratio in view of the quality of the exhaust gas and improving fuel efficiency.

Therefore, in this example embodiment, if the crank angle θd is equal to or less than the predetermined lower limit value, the fuel injection quantity is reduced to make the air-fuel ratio even leaner. Incidentally, this lower limit value also differs depending on the model of the engine and is therefore preferably set by testing using an actual engine.

Also, when making the air-fuel ratio leaner, the spark timing and the fuel injection timing may also be changed in addition to decreasing the fuel injection quantity.

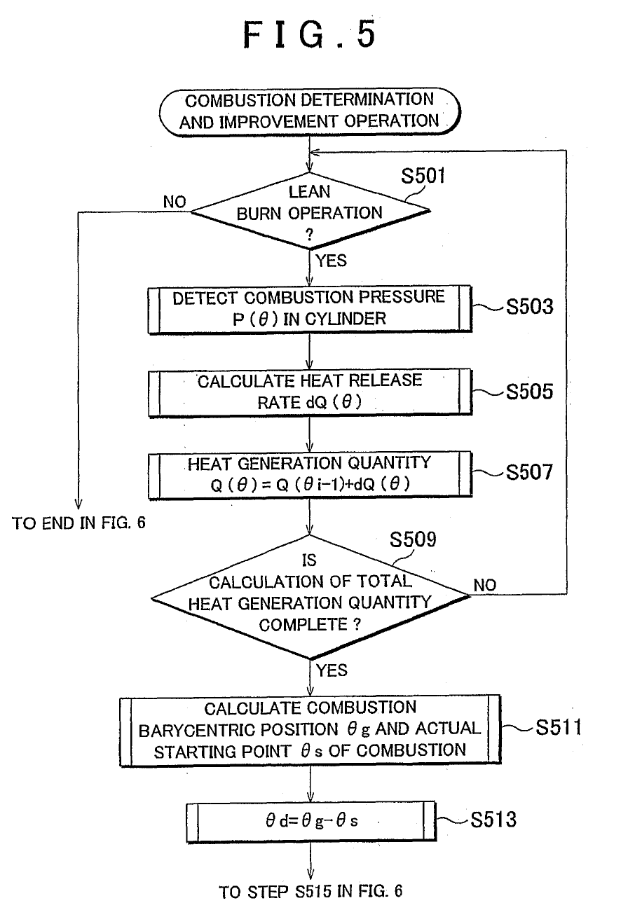

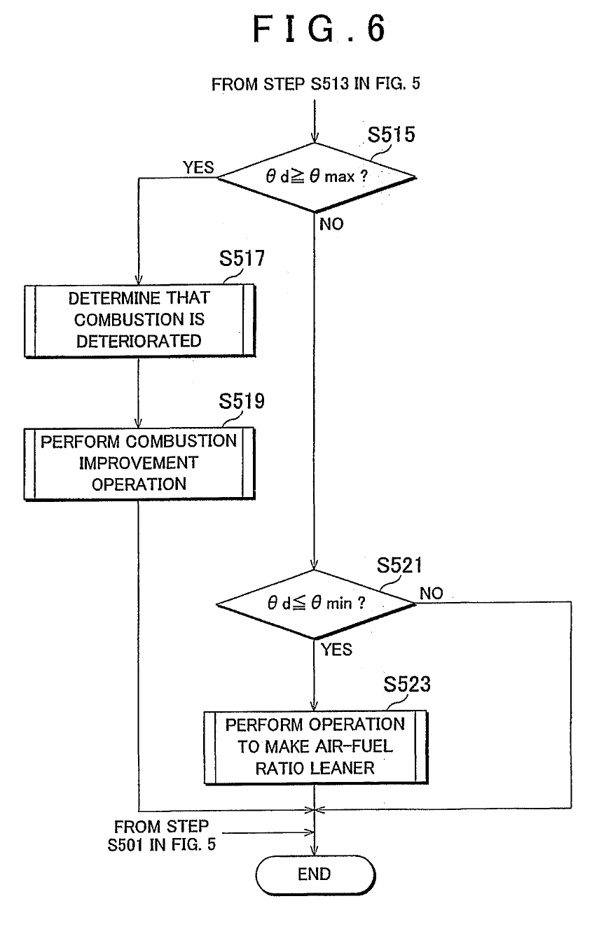

FIGS. 5 and 6 are first and second parts, respectively, of a flowchart illustrating the foregoing combustion determination operation and the combustion improvement operation which is based on the determination results of the combustion determination operation. These operations are performed by the ECU 30 executing the routine at fixed intervals.

When the operation shown in FIG. 5 starts, it is first determined in step S501 whether the engine is currently operating with a lean air-fuel ratio (i.e., whether lean burn operation is currently being performed). If lean burn operation is not being performed, the operation immediately ends without steps S503 and thereafter being executed.

That is, when lean burn operation is not being performed, the combustion determination operation is not executed. As described above, normal combustion with retarded ignition and abnormal combustion such as combustion in which the combustion barycentric position is retarded often occur during lean burn operation so there is less need to make the determination when lean burn operation is not being performed.

If it is determined in step S501 that lean burn operation is currently being performed, the process proceeds on to step S503 where the combustion pressure P(θ) in the cylinder is detected by the cylinder internal pressure sensors 11 to 14 at each crank angle in each cylinder. Then in step S505 the heat generation rate dQ(θ) at each crank angle is calculated based on the detected combustion pressure P(θ) in the cylinder and the combustion chamber volume V(θ). Incidentally, in this example embodiment, a value at each crank angle is calculated in advance for the combustion chamber volume V(θ) and stored in the ROM of the ECU 30 in the form of a numerical map with crank angle θ as a parameter.

Also, in step S507 the heat generation quantity integrated value Q(θ) at each crank angle is calculated by integrating the heat generation rate dQ(θ) calculated in step S505, and that heat generation quantity integrated value Q(θ) is stored in a predetermined area in the RAM of the ECU 30.

In step S509 it is determined whether the calculation of the total heat generation quantity is complete, i.e., whether a calculation period (crank angle) of the heat generation quantity, which is set is advance, has passed. In a cylinder in which the calculation of the total heat generation quantity is complete (i.e., YES in step S509), the combustion barycentric position θg and the actual starting position θs of combustion are calculated in step S511 by the methods described above. Then in step S513, the relative retard amount θd between the combustion barycentric position θg and the actual starting point θs of combustion is calculated as θd=θg−θs. Then steps S515 and thereafter (the part of the flowchart shown in FIG. 6) are executed.

The part of the flowchart that is shown in FIG. 6 illustrates the combustion determination operation and the combustion improvement operation based on the relative retard amount θd that was calculated in step S513.

That is, in step S515 in FIG. 6 it is determined whether the relative retard amount θd is equal to or greater than an upper limit value θmax that is set in advance. If the relative retard amount θd is equal to or greater than the upper limit value θmax (i.e., θd≧θmax), then it is determined in step S517 that abnormal combustion is occurring. In this case, the process proceeds on to step S519 where a combustion improvement operation such as increasing the fuel injection quantity by a fixed amount, advancing the spark timing by a fixed amount, or advancing the fuel injection timing by a fixed amount is performed.

That is, in the operations shown in FIGS. 5 and 6, a combustion improvement operation is performed every time the relative retard amount θd is equal to or greater than the upper limit value θmax (i.e., θd≧θmax) and the combustion state is improved so that the relative retard amount θd becomes less than the upper limit value θmax.

If, on the other hand, the relative retard amount θd is less than the upper limit value θmax (i.e., θd<θmax) in step S515, then it is next determined in step S521 whether the relative retard amount θd is equal to or less than a lower limit value θmin (i.e., θd≦θmin). As described above, if the relative retard amount θd is equal to or less than the lower limit value θmin (i.e., θd≦θmin), the air-fuel ratio can be made leaner. Therefore in this case, the fuel injection quantity is decreased by a fixed amount in step S523. As a result, the combustion state is controlled so that θd becomes greater than θmin by decreasing the fuel injection quantity by fixed amounts only when the relative retard amount θd is equal to or less than the lower limit value θmin (i.e., θd≦θmin) in step S521 each time the operations in FIGS. 5 and 6 are performed.

As described above, according to this example embodiment, it is possible to accurately distinguish between normal combustion with retarded ignition and true abnormal combustion. The combustion improvement operation is performed only when true abnormal combustion occurs so a good combustion state is able to be constantly maintained.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A combustion control apparatus for an internal combustion engine, comprising:
a cylinder internal pressure sensor that detects a combustion pressure in a cylinder; and
a control portion which i) calculates a heat generation quantity in the cylinder based on the detected combustion pressure, ii) calculates a combustion barycentric position which is a crank angle at which the heat generation quantity in the cylinder during one combustion cycle of the cylinder reaches a predetermined first ratio with respect to a total heat generation quantity in the cylinder in the combustion cycle, iii) detects an actual starting point of combustion, which is a crank angle at which combustion actually started in the cylinder; and iv) determines that a combustion state of the cylinder has deteriorated when a difference between the actual starting point of combustion and the calculated combustion barycentric position is greater than a determining value that is set in advance.

2. The combustion control apparatus for an internal combustion engine according to claim 1, wherein the first ratio is any value between 40% and 60%, inclusive.

3. The combustion control apparatus for an internal combustion engine according to claim 1, wherein the actual starting point of combustion is the crank angle at which the ratio of the heat generation quantity in the cylinder with respect to the total heat generation quantity in the cylinder reaches a predetermined second ratio which is smaller than the first ratio.

4. The combustion control apparatus for an internal combustion engine according to claim 3, wherein the second ratio is any value between 10% and 30%, inclusive.

5. The combustion control apparatus for an internal combustion engine according to claim 1, wherein the actual starting point of combustion is the crank angle at which an increase rate of the heat generation quantity in the cylinder per a predetermined unit crank angle becomes equal to or greater than a predetermined value.

6. The combustion control apparatus for an internal combustion engine according to claim 1, wherein the control portion improves combustion in the cylinder when it has been determined that combustion has deteriorated.

7. The combustion control apparatus for an internal combustion engine according to claim 6, wherein the control portion improves combustion in the cylinder by at least one of i) increasing a fuel injection quantity of the cylinder, ii) advancing a spark timing of the cylinder, and iii) advancing a fuel injection timing of the cylinder.

8. The combustion control apparatus for an internal combustion engine according to claim 1, wherein the control portion makes an air-fuel ratio leaner by decreasing a fuel injection quantity of the cylinder when the difference between the actual starting point of combustion and the combustion barycentric position is equal to or less than a predetermined lower limit value.

9. The combustion control apparatus for an internal combustion engine according to claim 1, wherein the control portion determines whether the combustion state of the cylinder has deteriorated only when the cylinder is being operated with an air-fuel ratio that is leaner than a predetermined air-fuel ratio.

10. A combustion control method for an internal combustion engine, comprising:
detecting a combustion pressure in a cylinder and calculating a heat generation quantity in the cylinder based on the detected combustion pressure;
calculating a combustion barycentric position which is a crank angle at which the heat generation quantity in the cylinder during one combustion cycle of the cylinder reaches a predetermined first ratio with respect to a total heat generation quantity in the cylinder in the combustion cycle;
detecting an actual starting point of combustion, which is a crank angle at which combustion actually started in the cylinder; and
determining that a combustion state of the cylinder has deteriorated when a difference between the actual starting point of combustion and the calculated combustion barycentric position is greater than a determining value that is set in advance.

11-19. (canceled)
